(19) United States
(12) Patent Application Publication
(10) Pub. No.: US 2004/0120315 A1
(43) Pub. Date: Jun. 24, 2004

(54) Communication system for peer-to-peer communication between optical network units in Ethernet-based passive optical network and communication method thereof

(76) Inventors: Kyeong-Soo Han, Daejeon (KR); Tae-Whan Yoo, Daejeon (KR); Ho-Sook Lee, Jeonju (KR); Hyeong-Ho Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/615,621

(22) Filed: Jul. 8, 2003

(30) Foreign Application Priority Data
Dec. 24, 2002 (KR) 2002-83717
Apr. 21, 2003 (KR) 2003-25090

(51) Int. Cl. H04L 12/56

(52) U.S. Cl. 370/389; 370/535

(57) ABSTRACT

A communication system using a layering architecture that supports peer-to-peer communication between ONUs in an Ethernet-based PON. The system includes a physical layer receiving frames from an OLT; and data link layers including an emulation layer, a MAC layer, a MAC control layer, and a MAC emulation layer. The data link layers further include a P2PE layer for generating and managing an address table that matches PON-tags of frames received from ONUs and transmission point addresses, and a mirror address table of the address table, and an FRM layer for performing, according to a target address of the frames, an upstream process that transmits frames to an upper layer and a downstream process that transmits frames to a lower layer.

### CROSS REFERENCE TO RELATED APPLICATION

This application is based on Korea Patent Applications No. 2002-83717 filed on Dec. 24, 2002 and No. 2003-25090 filed on Apr. 21, 2003 in the Korean Intellectual Property Office, the content of which is incorporated herein by reference.

### BACKGROUND OF THE INVENTION

(a) Field of the Invention

The present invention relates to an OLT (optical line termination) layering architecture for supporting peer-to-peer communication between ONUs (optical network units) in an Ethernet-based passive optical network (EPON), and to a communication method thereof.

(b) Description of the Related Art

In existing Ethernet systems, all terminals or nodes belonging to the same LAN segment simultaneously receive the same frame. However, when sending a frame from one ONU to another ONU in a PON network, it is necessary for the ONU to transmit the frame to an OLT, after which the OLT sends this frame to the corresponding ONU after checking the destination address. But in the existing Ethernet standard, it is not possible for an OLT to send a received frame to an ONU. Various ways to solve this problem in an EPON have been disclosed.

In a first conventional method, emulation layering for peer-to-peer communication is provided between a PHY (physical) layer and a MAC (media access control) layer. Such a method is divided into two different types of methods. In one of the methods, all frames received from an ONU are sent to an upper layer after removing a PON-tag in an emulation layer, and, at the same time, these frames are copied and transmitted to all ONUs through a PON interface. The ONUs check the PON-tag, and if it is the same as its own PON-tag, filtering is performed and the frame is discarded. If the PON-tag is not the same as its own PON-tag, the PON-tag is removed and the frame is forwarded to an upper layer. With this method, since all frames are sent to the PON interface even when there is no peer-to-peer communication between ONUs, there is significant downstream bandwidth waste in the PON network.

In the other of the two methods (that the above first conventional method is divided into), the frames from each ONU are divided according to their appended PON-tag and sent to upper MAC layers. The upper MAC layers include as many logical MAC layers as there are ONUs, which are connected to the PON interface, and each MAC layer is connected to a bridge port. The frames undergo switching through the bridges to be lowered through the corresponding MAC layer. The frames undergoing switching in the bridges to be lowered are attached with a PON-tag corresponding to the target address, and transmitted through the PON interface to the ONUs. Each of the ONUs determines the PON-tag of the received frame, and if the PON-tag corresponds to its own PON-tag, the PON-tag is removed and the frame is transmitted to an upstream layer. If the PON-tag does not correspond to its own PON-tag, filtering is performed and the frame is discarded. With this method, frame multiplexing is realized in each MAC layer, and multiplexing must be performed once again between the MAC layers. Frame multiplexing, therefore, becomes complex, and there must be provided as many logical MAC layers (with respect to one PON interface) as there are ONUs.

In a second conventional method, a shared LAN emulation function is provided to an upper of the MAC layer of the OLT. Shared LAN emulation is comprised of lower layer shared LAN emulation, logical MACs, and upper layer shared LAN emulation. Lower layer shared LAN emulation checks a LLID (logical link ID) of the frame forwarded from an ONU and provides the same to a corresponding logical MAC. The logical MAC passes this frame to the upper layer shared LAN emulation. The upper layer shared LAN emulation performs the same function as the IEEE802.1D bridge, and, to perform peer-to-peer communication, determines the LLID of the frame and sends the frame to the corresponding logical MAC.

In the logical MAC, the LLID is set and the frame is sent to a lower layer. In the case of a broadcast, the frame is sent through a separate broadcasting logical MAC, in which case the broadcasting bit is set. In this case, a k number of logical MACs is present (where k is the number of LLIDs *2+1), and the frame needs to be changed to a form different from the standard form to realize the shared LAN emulation. However, there is no reference to the precise form the frame needs to take in the literature describing this method. Further, since multiplexing is required between each logical MAC, multiplexing becomes complicated with respect to downstream data.

### SUMMARY OF THE INVENTION

It is an advantage of the present invention to provide an OLT layering architecture for supporting peer-to-peer communication between ONUs (optical network units) in an Ethernet-based passive optical network (EPON).

In particular, the present invention enables peer-to-peer communication between ONUs while minimizing variations in the existing Ethernet standard, and simplifies the layering architecture.

In one aspect of the present invention, a communication system supporting peer-to-peer communication between ONUs in an Ethernet-based PON comprises: a physical layer receiving frames (including frames to which PON-tags have been attached to their preambles) transmitted from an OLT (optical line termination); and data link layers including an emulation layer, a MAC layer, a MAC control layer, and a MAC emulation layer that process frames received through the physical layer, wherein the data link layers further include a P2PE layer positioned between the emulation layer and the MAC layer, for generating and managing (1) an address table that matches PON-tags of frames received from ONUs and transmission point addresses, and (2) a mirror address table of the address table; and a FRM (frame reflecting and multiplexing) layer positioned between the MAC control layer and the MAC emulation layer, for performing, according to a target address of the frames, an upstream process that transmits or broadcasts frames to an upper layer and a downstream process that transmits or broadcasts frames to a lower layer.

The P2PE layer comprises: a frame receiver receiving a first frame transmitted from the physical layer; an address table processor generating the address table that matches a PON-tag of the first frame with a transmission point address, and generating the mirror address table of the address table; a frame processor transmitting the first frame to an upper layer; a search unit receiving a second frame transmitted from an upper layer, and searching the address table to find a PON-tag corresponding to a target address of the second frame; and a PON-tag processor attaching a PON-tag corresponding to the target address to a preamble of the second frame.

The FRM layer comprises: an address determining unit generating and managing an upper address table, and determining a target address of the first frame input based on the mirror address table and the upper address 15 table; and an upstream frame processor forwarding the first frame to an upstream layer or reflecting toward an ONU according to address determination results.

The upstream frame processor transmits the first frame to an upper bridge if the target address of the first frame is an external address of the EPON, broadcasts the first frame to an upstream layer and in an ONU direction in the case where the target address of the first frame is not in the upper address table and the mirror address table or it is a broadcast address, and returns the first frame to a downstream layer if the target address of the first frame is in the mirror address table.

The FRM layer further comprises a downstream frame processor that flags a target address of a second frame transmitted from an upper layer in the address table, and wherein the search unit searches only addresses flagged by the downstream frame processor in the address table, finds PON-tags corresponding to target addresses of downstream frames, and transmits the PON-tags to the PON-tag processor.

The PON-tag processor attaches a broadcasting PON-tag to a preamble of the second frame in the case where the target address of the second frame is not in the address table, and transmits the broadcasting PON-tag to the physical layer.

The FRM layer performs a multiplexing function between the second frame from an upstream layer and the frame reflected in the FRM.

In another aspect of the present invention, a communication method for a system supporting peer-to-peer communication between ONUs in an Ethernet-based PON comprises: (a) receiving a first frame from the ONUs; (b) generating an address table that matches a PON-tag of the first frame and a transmission point address, and generating a mirror address table of the address table; (c) generating and managing an upper address table, and determining a target address of the first frame based on the mirror address table and the upper address table; and (d) forwarding to an upper layer or reflecting to an ONU the first frame based on results of the address determination.

The method further comprises: (e) receiving a second frame transmitted from an upper layer, and searching the address table to find a PON-tag corresponding to the target address of the second frame; and (f) attaching the PON-tag corresponding to the target address to the preamble of the second frame, and transmitting the PON-tag to a physical layer.

The (d) comprises: transmitting the first frame to an upper bridge in the case where the target address of the first fame is an external address of the EPON; broadcasting the first frame to an upstream layer and in an ONU direction in the case where the target address of the first frame is not in the upper address table and the mirror address table or it an a broadcast address; and returning the first frame to a downstream layer if the target address of the first frame is in the mirror address table.

The (e) comprises: flagging the target address of the second frame transmitted from an upper layer in the address table; and searching only addresses flagged in the address table, and finding a PON-tag corresponding to a target address of a downstream frame.

It is preferable that in the communication method, the system has the same layering structure as the communication system described above.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of an EPON according to an embodiment of the present invention.

FIG. 2 is a schematic view of an EPON layering architecture according to an embodiment of the present invention.

FIG. 3 is a schematic view of an FRM (frame reflection and multiplexing) and P2PE architecture according to an embodiment of the present invention.

FIGS. 4 and 5 are views used to illustrate operations of P2PE and FRM layers according to an embodiment of the present invention.

### DETAILED DESCRIPTION OF THE PREFERRED EMBODIMENTS

An embodiment of the present invention will now be described in detail with reference to the accompanying drawings. As will be realized, the invention is capable of modification in various obvious respects, all without departing from the invention. Accordingly, the drawings and description are to be regarded as illustrative in nature, and not restrictive.

The present invention supports re-transmission in ports for transmitting frames between ONUs that exist in identical ports. Existing Ethernet bridges do not provide such support. A PON network is a network having a medium-shared tree architecture. Unlike the medium sharing of the existing Ethernet, in the fiber and splitter OLT, a downstream frame to an ONU is transmitted to all ONUs. Also, an upstream frame transmitted from an ONU can be received only from an OLT and not from other ONUs.

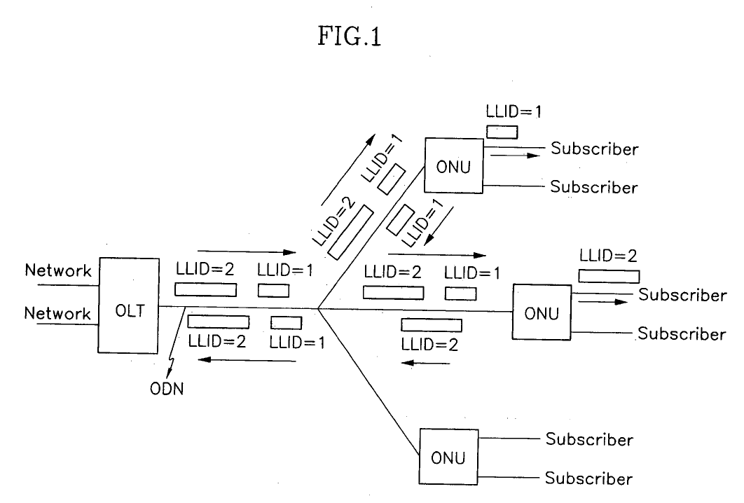

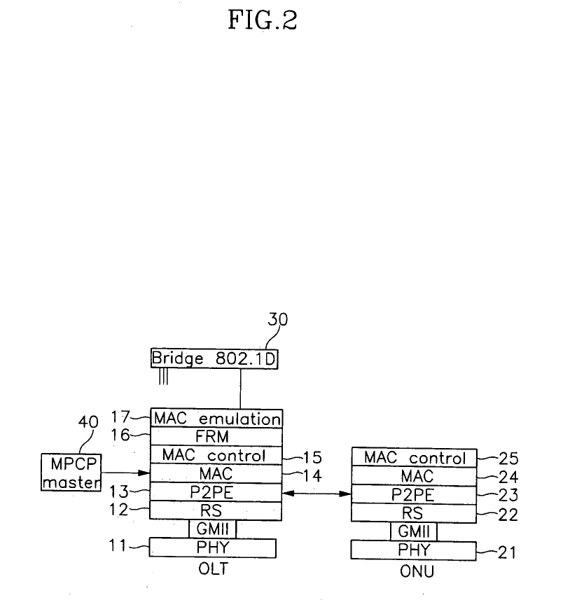

FIG. 1 is a schematic view of an Ethernet-based passive optical network (EPON) according to an embodiment of the present invention, and FIG. 2 is a schematic view of an EPON layering architecture according to an embodiment of the present invention.

The present invention provides peer-to-peer communication between ONUs in an EPON network. An EPON network is an Ethernet-based PON network. As shown in FIG. 1, an EPON network includes an OLT (optical line termination), an ODN (optical distribution network), and an ONU (optical network unit). In a single EPON network, a plurality of ONUs is connected to one OLT through an ODN. The ODN includes a fiber and optical splitter. Communication between the ONUs is realized through the OLT. In an existing Ethernet network, the ONUs and the OLT are interconnected by a peer-to-peer configuration or through a bus. Further, in the existing Ethernet network, the frames transmitted by an ONU are received by all ONUs and the OLT such that no problems occur in communication between the ONUs.

However, in an EPON network, the OLT and the ONUs are connected individually through an ODN, the frames transmitted from the OLT by a directivity of the fiber and optical splitter are broadcast to all the ONUs, and the frames transmitted from the ONUs are unable to be received by other ONUs, only by the OLT. Therefore, in order to realize communication between the ONUs, the OLT must determine a target address of the frames received from the ONUs then transmit the frames to the corresponding ONUs.

In Ethernet, frame relay is realized in a bridge. According to the IEEE802.1D standard, which designates bridge function, frames that are received cannot be returned to the port that receives the frames. Adhering to the IEEE802.1D standard, a peer-to-peer emulation function in a FRM (frame reflection and multiplexing) function and a RS secondary layer are proposed to enable communication between ONUs in an EPON network.

To provide such a function, an OLT according to an embodiment of the present invention is realized through the following layer architecture.

With reference to FIG. 2, an OLT according to an embodiment of the present invention includes a physical layer and a data link layer.

As a physical layer in an Ethernet-based PON, the physical layer 11 may include a PCS (physical coding sublayer), a PMA (physical media attachment), and a PMD (physical media dependent).

Data link layers (12_17) include an emulation layer (RS, reconciliation sublayer) 12, a P2PE layer 13, a MAC layer 14, a MAC control layer 15, a FRM layer 16, and a MAC emulation layer 17.

The data link layers and the physical layer transmit data through a GMII (gigabit media independent interface). The GMII performs an interface function that can process Ethernet frames at a speed of 1 gigabit or less through an interface standard.

In the emulation layer 12, a CRC (cyclic redundancy check) with respect to information contained in a preamble of frames raised from the physical layer 11. In particular, a PON-tag provided from an ONU provides to an upper layer a frame attached to a preamble.

The P2PE layer 13 checks the frame received from an ONU, and the PON-tag of the frame and a calculating table (i.e., an address table T1) of the transmission point address are generated and managed. A mirror address table T1 of this address table is simultaneously generated and managed.

The MAC layer 14 performs in an upstream direction FCS generation with respect to a control frame (among the Ethernet frames transmitted from the MAC control layer 15) used for MPCP (multi point control protocol), IFG (inter frame gap) insertion, and MIB (management information base) counter management with respect to downstream frames. In an upstream direction, the MAC layer 14 performs FCS (frame check sequence) inspection, address filtering, and MIB counter management with respect to upstream frames.

The MAC control layer 15 is a layer that performs a bandwidth allocation function in the case of an OLT, scheduling, and other MAC control processes.

The MAC layer 14 and the MAC control layer 15 form a general system architecture for Ethernet PON, and their operation is designated by the IEEE802.3 standard, Therefore, a detailed description of these elements will not be provided.

Frames processed in the P2PE layer 13 are transmitted to the FRM layer 16 through the upper MAC layer 14 and the MAC control layer 15.

In the FRM layer 16, upstream processing to broadcasting or to an upper bridge according to the target address of the frame, and downstream processing of frame transmission to a downstream layer are performed. Also, the FRM layer 16 performs a multiplexing function between downstream frames lowered from an upper layer and between frames reflected in the FRM.

In more detail, for an EPON external address, the frames are sent to an upper bridge, while for a broadcasting address or an unknown address, the frames are broadcast to a bridge and a PON interface. Further, if the target address is in the address table T1 generated in the P2PE layer 13, the frames are sent to a lower layer. The FRM layer 16 also performs a multiplexing function with respect to lower frames.

The MAC emulation layer 17 has the same function as the MAC function, however, except for part of the management function, it mainly performs the operation of matching upstream and downstream Ethernet frames, FCS inspection, and PAUSE frame processing.

A bridge 30 performs a basic simple bridge function with respect to EPON, and performs communication between ONUs and VLAN multicast in the PON system through generation and management of a filtering address table for target point MAC addresses for each PON-tag and VLAN (virtual LAN) IDs.

For ease of explanation, the P2PE layer 13 and the emulation layer 12 are described as separate elements, as are the FRM layer 16 and the MAC emulation layer 17. However, the P2PE layer 13 is actually included in the emulation layer 12, and the FRM layer 16 is included in the MAC emulation layer 17.

The ONU, with reference to FIG. 2, includes a physical layer 21 and data line layers 22_25. The data link layers include, as with the OLT, an emulation layer 22, a P2PE layer 23, a MAC layer 24, and a MAC control layer 25. No FRM layer is included in the ONU, unlike with the OLT.

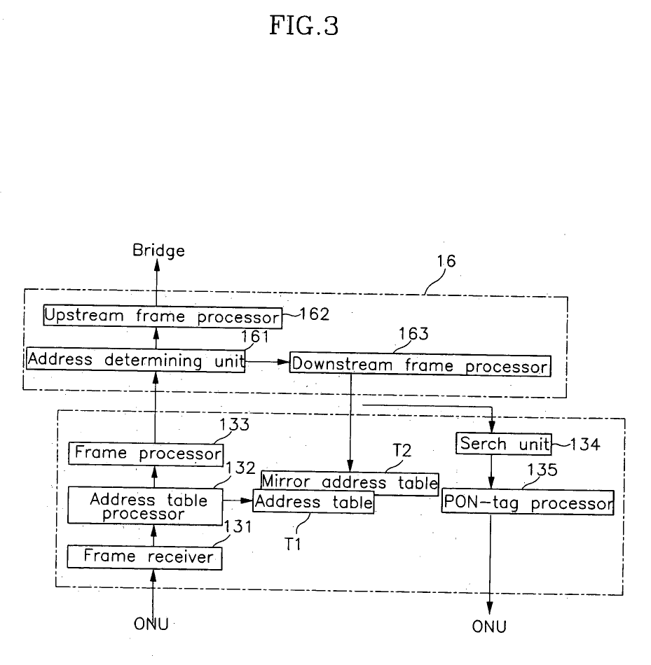

The above layering architecture for enabling communication between ONUs in an EPON while adhering to the standard in which, if a frame is received, the frame is unable to be returned to the received port, and for performing an operation between the P2PE layer 13 and the FRM layer 16 will be described with reference to FIG. 3.

As shown in FIG. 3, the P2PE layer 13 includes a frame receiver 131 for receiving frames transmitted from a downstream layer; an address table processor 132 for generating and managing PON-tags attached to a preamble of received frames, the address table T1 of transmission point addresses, and the mirror address table T2 of the address table T1; and a frame processor 133 for transmitting frames to an upstream layer. The P2PE layer 13 also includes a search unit 134 and a PON-tag processor 135 for processing downstream frames transmitted from an upstream layer.

The FRM layer 16 includes an address determining unit 161 for receiving upstream frames having undergone address management processes and determining corresponding target addresses, an upstream frame processor 162 for broadcasting or transmitting frames according to their address, and a downstream frame processor 163 for flagging addresses with respect to downstream frames transmitted from the upper MAC emulation layer 17.

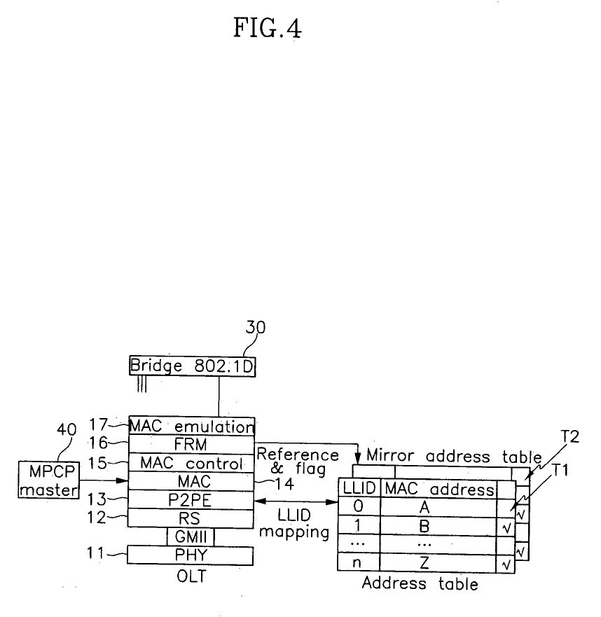

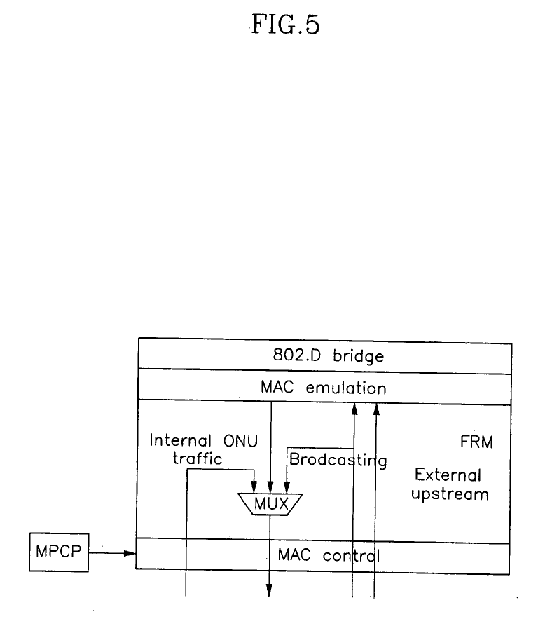

FIGS. 4 and 5 are views used to illustrate operations based on the above structures of the P2PE layer 13 and the FRM layer 16.

For example, in an ONU, and in particular in the P2PE layer 13, PON-tags allocated from the OLT are attached to the preambles of frames and the frames are transmitted to the OLT. The frames with the attached PON-tags are transmitted to data link layers through the physical layer 11 of the OLT.

With reference to FIG. 4, the frame receiver 131 of the P2PE layer 13 receives frames transmitted from the physical layer 11, and the address table processor 132 generates frame PON-tags and the address table T1, which is the calculating table for the transmission point addresses, and also generates the mirror address table T2 of this address table T1.

The address table T1 is an address table for MAC addresses with respect to terminals of the ONUs connected to the PON interface. Using the address table T1, the OLT is able to determine the addresses of the terminals connected to the PON interface. When the address table T1 is generated, the OLT determines the SA (source address) of the frame received from the PON interface, and if it is a new SA, updates the address table T1 by adding the new SA thereto. The mirror address table T2 is an exact copy of the address table T1 and is also updated by copying the address table T1 every time the address table T1 is updated. The address table T1 is generated in the P2PE layer 13, and since it is copied in the mirror address table T2, it is possible for only the mirror address table T2 to be read in the FRM layer 16.

The frame processor 133 transmits the received frames to the FRM layer 16 via the upper MAC layer 14 and MAC control layer 15.

If an Ethernet frame entering through the OLT port is transmitted, the address determining unit 161 of the FRM layer 16 determines whether to forward the frame or reflect the same to an ONU by referencing the mirror address table T2 of the address table T1 generated in the P2PE layer 13. Upper address tables are generated and managed in the FRM layer 16. The address determining unit 161 provides the results of the determination to the frame processor 162.

The upper address tables are generated based on SAs of the frames received not from the PON interface but from the network interface of the opposite side. The FRM layer 16 generates these upper address tables, and when it is determined to forward the frames, determines the forwarding direction by referencing the address table and mirror address table. That is, if an Ethernet frame is received from the PON interface, the address determining unit 161 first reads the target address of the received frame, then compares this with the addresses in the mirror address table and the upper address table.

Depending on the results of this comparison, the upstream frame processor 162, with reference to FIG. 5, sends the received frame to an upper bridge if the target address of the received frame is an external network of the EPON, and broadcasts the received frame to a bridge and the PON interface if the target address is a broadcasting address or is unknown. That is, if the target address of the received frame corresponds to one of the addresses in the mirror address table T2, the received frame is sent to a downstream layer IS to be reflected in the ONU direction. Further, if the target address of the received frame does not correspond to one of the addresses in the mirror address table T2, and if one of the addresses of the address table corresponds to the target address of the received frame (in the case where the target address of the received frame is an external address of the EPON), the received frame is forwarded upstream. Finally, if the target address of the received frame does not correspond to an address of the mirror address table T2 or an address of the address table, or if the target address is a broadcasting address, the received frame is forwarded upstream and simultaneously reflected to the ONU (or broadcasted).

If a downstream frame transmitted through the MAC emulation layer 17 is received, the downstream frame processor 163 of the FRM layer 16 flags an address (target address) of the address table generated and managed in the P2PE layer 13 with respect to a downstream frame moving in an ONU direction, and transmits the downstream frame to a lower layer.

Next, if the downstream frame is transmitted to the P2PE layer 13 through the MAC control layer 15 and the MAC layer 14, the search unit 134 of the P2PE layer 13 searches only the addresses flagged in the FRM layer 16, and finds PON-tags corresponding to the target address of the downstream frame and provides the PON-tags to the PON-tag processor 135. The flagging function of the FRM allows for quick address searching.

Accordingly, the PON-tag processor 135 attaches a PON-tag matching the target address to a preamble of the downstream frame, then the frame is transmitted to a lower layer. For example, a frame from the FRM layer 16 is transmitted after being attached with a PON-tag corresponding to the transmitting address by referencing the address table T1 or with a broadcasting PON-tag. In the case where the frame is from an ONU, since there is a transmission point address in the address table if the frame is received by being reflected in the FRM layer 16, a corresponding PON-tag is attached to the frame, while in the case where the frame is from an external frame, since it is not in an address table, a broadcasting PON-tag is attached to the frame.

As a result, a frame received from the OLT undergoes filtering in the ONU by determining its PON-tag in the P2PE layer 13. If the PON-tag of the received frame is the same as its own or is a broadcasting PON-tag, the ONU removes the PON-tag of the preamble then sends the frame to an upper MAC layer, while if different from its own PON-tag, the ONU performs filtering to discard the frame.

In the embodiment of the present invention described above, peer-to-peer communication between ONUs is supported while using the existing Ethernet protocol in an Ethernet-based PON network.

Further, since only corresponding frames are transmitted to PON links through an address table, link efficiency is increased. Also, during address searching, flags are used so that PON-tags corresponding to only flagged addresses are searched to thereby reduce the time needed for searching.

In addition, the substantial variations in the Ethernet standard reduce compatibility with existing Ethernet networks, and the complicated architecture increases the difficulties involved in application. However, according to the present invention, a plurality of logical MACs are not employed and instead only a single MAC is used as with the existing Ethernet, and the layering architecture under the MAC layer is not changed.

Furthermore, compatibility with an Ethernet network is maintained without changing the form of the Ethernet frames, and the emulation block function for supporting peer-to-peer communication is simplified. Finally, the generation and management of address tables for peer-to-peer communication may be efficiently performed, and address tables may be quickly searched.

Although an embodiment of the present invention has been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A communication system supporting peer-to-peer communication between ONUs (optical network units) in an Ethernet-based PON (passive optical network), the system comprising:
a physical layer receiving frames (including frames to which PON-tags have been attached to their preambles) transmitted from an OLT (optical line termination); and
data link layers including an emulation layer, a MAC layer, a MAC control layer, and a MAC emulation layer that process frames received through the physical layer,
wherein the data link layers further include a P2PE layer positioned between the emulation layer and the MAC layer, for generating and managing (1) an address table that matches PON-tags of frames received from ONUs and transmission point addresses, and (2) a mirror address table of the address table; and
a FRM (frame reflecting and multiplexing) layer positioned between the MAC control layer and the MAC emulation layer, for performing, according to a target address of the frames, an upstream process that transmits or broadcasts frames to an upper layer and a downstream process that transmits or broadcasts frames to a lower layer.

2. The system of claim 1, wherein the P2PE layer comprises:
a frame receiver receiving a first frame transmitted from the physical layer;
an address table processor generating the address table that matches a PON-tag of the first frame with a transmission point address, and generating the mirror address table of the address table;
a frame processor transmitting the first frame to an upper layer;
a search unit receiving a second frame transmitted from an upper layer, and searching the address table to find a PON-tag corresponding to a target address of the second frame; and
a PON-tag processor attaching a PON-tag corresponding to the target address to a preamble of the second frame.

3. The system of claim 2, wherein the FRM layer comprises:
an address determining unit generating and managing an upper address table, and determining a target address of the first frame input based on the mirror address table and the upper address table; and
an upstream frame processor forwarding the first frame to an upstream layer or reflecting toward an ONU according to address determination results.

4. The system of claim 3, wherein the upstream frame processor transmits the first frame to an upper bridge if the target address of the first frame is an external address of the EPON,
broadcasts the first frame to an upstream layer and in an ONU direction in the case where the target address of the first frame is not in the upper address table and the mirror address table or it is a broadcast address, and
returns the first frame to a downstream layer if the target address of the first frame is in the mirror address table.

5. The system as in either claim 2, wherein the FRM layer further comprises a downstream frame processor that flags a target address of a second frame transmitted from an upper layer in the address table, and
wherein the search unit searches only addresses flagged by the downstream frame processor in the address table, finds PON-tags corresponding to target addresses of downstream frames, and transmits the PON-tags to the PON-tag processor.

6. The system of claim 5, wherein the PON-tag processor attaches a broadcasting PON-tag to a preamble of the second frame in the case where the target address of the second frame is not in the address table, and transmits the broadcasting PON-tag to the physical layer.

7. The system of claim 1, wherein the FRM layer performs a multiplexing function between the second frame from an upstream layer and the frame reflected in the FRM.

8. A communication method for a system supporting peer-to-peer communication between ONUs in an Ethernet-based PON, the method comprising:
(a) receiving a first frame from the ONUs;
(b) generating an address table that matches a PON-tag of the first frame and a transmission point address, and generating a mirror address table of the address table;
(c) generating and managing an upper address table, and determining a target address of the first frame based on the mirror address table and the upper address table; and
(d) forwarding to an upper layer or reflecting to an ONU the first frame based on results of the address determination.

9. The method of claim 8, further comprising:
(e) receiving a second frame transmitted from an upper layer, and searching the address table to find a PON-tag corresponding to the target address of the second frame; and
(f) attaching the PON-tag corresponding to the target address to the preamble of the second frame, and transmitting the PON-tag to a physical layer.

10. The method of claim 8, wherein (d) comprises:
transmitting the first frame to an upper bridge in the case where the target address of the first fame is an external address of the EPON;
broadcasting the first frame to an upstream layer and in an ONU direction in the case where the target address of the first frame is not in the upper address table and the mirror address table or it an a broadcast address; and
returning the first frame to a downstream layer if the target address of the first frame is in the mirror address table.

11. The method of claim 9, wherein (e) comprises:
flagging the target address of the second frame transmitted from an upper layer in the address table; and
searching only addresses flagged in the address table, and finding a PON-tag corresponding to a target address of a downstream frame.
